(19) United States
(12) Patent Application Publication
(10) Pub. No.: US 2015/0201255 A1
(43) Pub. Date: Jul. 16, 2015

(54) Portable Studio Monitor System

(71) Applicant: Fender Musical Instruments Corporation, Scottsdale, AZ (US)

(72) Inventor: Kenneth W. Porter, Scottsdale, AZ (US)

(73) Assignee: Fender Musical Instruments Corporation, Scottsdale, AZ (US)

(21) Appl. No.: 14/153,823

(22) Filed: Jan. 13, 2014

(51) Int. Cl. H04R 1/00

(52) U.S. Cl. CPC H04R 1/00

(57) ABSTRACT

A portable studio monitor system has a first monitor and a second monitor. The first monitor has a first securing assembly. The second monitor has a second securing assembly. The first securing assembly and second securing assembly are configured to secure the first monitor to the second monitor and prevent the first and second monitors from unintentionally separating. The first monitor has a first handle. The second monitor has a second handle. A handle grip is disposed over the first handle and the second handle to prevent the first monitor from separating from the second monitor. The first securing assembly includes a first portion of a bump/receptacle mechanism and the second monitor includes a second portion of the bump/receptacle mechanism. The first and second monitors each include a baffle disposed over a hollow outer cabinet. A plurality of ribs is formed over the sidewalls of the hollow outer cabinet.

### FIELD OF THE INVENTION

The present invention relates in general to audio sound systems and, more particularly, to a portable studio monitor system and method of forming a portable studio monitor system.

### BACKGROUND OF THE INVENTION

In sound recording and reproduction, mixing audio is a process by which multiple recorded sounds or source recordings, e.g., vocal tracks, instrumental tracks, sound effects, etc., are combined into one or more channels, for example 2-channel stereo. During the mixing process, a source recording's level, frequency content, dynamics, and panoramic position are manipulated and effects, e.g., reverberation (reverb), are added. The mixing process is generally carried out by a mixing engineer, or mixer, using a mixing console or digital audio workstation (DAW) that is connected to a set of studio monitors.

Studio monitors are a type of loudspeaker used for mixing audio. Studio monitors produce an accurate, flat frequency response. Studio monitors do not emphasize or deemphasize a particular frequency, i.e., low frequencies, midrange frequencies, and high frequencies are all output a same level. Studio monitors allow a listener to hear an accurate, uncolored reproduction of the tonal qualities of an audio signal. Critical listening by a mixer and accurate reproduction of the audio signal by the monitors are crucial to the mixing process.

The advent of powerful portable recording workstations and the increasing convenience of all-in-one audio production kits are allowing both a professional and novice artist to record and mix audio from anywhere using DAW software, a personal computer, and headphones. However, mixing audio through headphones causes certain tracks to be heard too clearly and to sound too present, which makes finding an ideal volume for the track difficult. For example, through headphones a lead vocal track or a solo instrument track is heard clearly, even when the track is quiet or on a lower volume. Because the a quiet track is heard clearly, the artist or mixer makes the track lower in the mix than the track should be, resulting in a mix that is not acoustically appealing. Mixing with headphones also causes a mixer to miss a physical impact of bass instruments, i.e., the part of a track a listener feels rather than hears. In addition, an audio signal heard through headphones can sound unnatural because headphones cause a listener to hear certain parts of an audio signal in one ear and other parts of the audio signal in the other ear. For example, when listening through headphones, a right channel of the audio signal is heard only in a listener's right ear and a left channel of the audio signal is heard only in the listener's left ear. The audio signal sounds unnatural when heard through headphones because people are not accustomed to hearing discrete parts of an audio signal in each ear separately. Rather, people are accustomed to hearing all parts of an audio signal in both ears after the sound waves corresponding to each part of the audio signal have mixed in air. Mixing audio with headphones does not allow a mixer to appreciate what an audience experiences when hearing all parts or the audio signal with both ears.

Sound waves output from studio monitors naturally mix in air and allow a mixer to hear all parts of an audio signal with both ears. Studio monitors also allow a mixer to hear how the acoustics of a room affect a localization of the sound waves and the mixer can adjust and manipulate various levels and properties of the audio signals accordingly. However, studio monitors that produce a dynamic, precise, and uncolored reproduction of the tonal qualities of the audio signals being mixed are large, heavy, and difficult to transport. The general immobility of studio monitors makes the monitors a permanent fixture of a particular location, e.g., a recording studio. Accordingly, an artist can only mix audio using studio monitors if the artist goes to a location that already possesses a set of studio monitors. In addition, each set of studio monitors has a unique sonic signature with tonal qualities that are different from the tonal qualities and sonic signature of the next set of studio monitors. A mixer needs to be familiar with the sonic signature of a particular set of monitors to create acoustically pleasing mixes. A mixer cannot make wise production decisions if the mixer is unfamiliar with the tonal characteristics of the monitors' audio output. Accordingly, a mixer wastes valuable and, often times, expensive production time, becoming familiar with a new set of monitors at each new location.

### SUMMARY OF THE INVENTION

A need exists for a portable, high quality studio monitor system. Accordingly, in one embodiment, the present invention is a portable speaker system comprising a first monitor including a first securing assembly. A second monitor is disposed adjacent to the first monitor and includes a second securing assembly. The first securing assembly and second securing assembly are configured to secure the first monitor to the second monitor.

In another embodiment, the present invention is a portable speaker system comprising a first speaker including a first securing assembly and a second speaker including a second securing assembly. The first securing assembly and second securing assembly are configured to secure the first enclosure to the second enclosure.

In another embodiment, the present invention is a portable speaker system comprising a first speaker and a second speaker. A securing assembly is coupled to the first speaker and is configured to secure the first speaker to the second speaker.

In another embodiment, the present invention is a method of forming a portable speaker system comprising the steps of providing a first speaker, providing a second speaker, and securing the first speaker to the second speaker.

### BRIEF DESCRIPTION OF THE DRAWINGS

FIGS. 1a-1d illustrate a portable studio monitor system in travel mode;

FIGS. 2a-2d illustrate a master monitor of a portable studio monitor system;

FIGS. 3a-3g illustrate a remote monitor of a portable studio monitor system;

FIGS. 4a-4c illustrate connecting a portable studio monitor system to various audio sound sources;

FIG. 5 illustrates a functional block diagram of a portable studio monitor system; and

FIGS. 6a-6h illustrate placing a portable studio monitor system in travel mode.

### DETAILED DESCRIPTION OF THE DRAWINGS

The present invention is described in one or more embodiments in the following description with reference to the figures, in which like numerals represent the same or similar elements. While the invention is described in terms of the best mode for achieving the invention's objectives, those skilled in the art will appreciate that the disclosure is intended to cover alternatives, modifications, and equivalents as may be included within the spirit and scope of the invention as defined by the appended claims and the claims' equivalents as supported by the following disclosure and drawings.

When mixing audio, multiple individual source recordings are combined or mixed together to produce a final product, for example, a song. The mixing process generally follows a multitrack recording process, in which multiple individual source audio files or tracks are recorded. During the mixing process, the individual source tracks are combined and manipulated by a sound engineer or mixer. While usually associated with music production, mixing audio is employed in a wide range of applications including post-production of video and film, live sound reinforcement, advertising, multimedia, and broadcasting. In all forms of mixing audio, producing a finished product that will be acoustically appealing to audiences or listeners requires critical listening on the part of the mixer.

Studio monitors are a type of loudspeaker specifically designed for audio production applications, in which accurate audio reproduction is crucial. The term monitor refers to a speaker that is designed to produce relatively flat (i.e., linear) phase and frequency responses. A studio monitor is designed to exhibit minimal emphasis or de-emphasis of particular frequencies, i.e., the bass or low frequencies (between approximately 60 hertz (Hz) and 250 Hz), the midrange frequencies (between approximately 250 Hz and 6000 Hz), and the treble or high frequencies (above approximately 6000 Hz) of a source track are all played at about the same level. A studio monitor gives an accurate, uncolored reproduction of the tonal qualities of the source audio signal. True and accurate speakers are important because an accurate reproduction of the audio signal allows the mixer to get a better sense of how a finished product will translate, i.e., how the final mix will sound when played on different media, for example, through a portable music player or on car speakers.

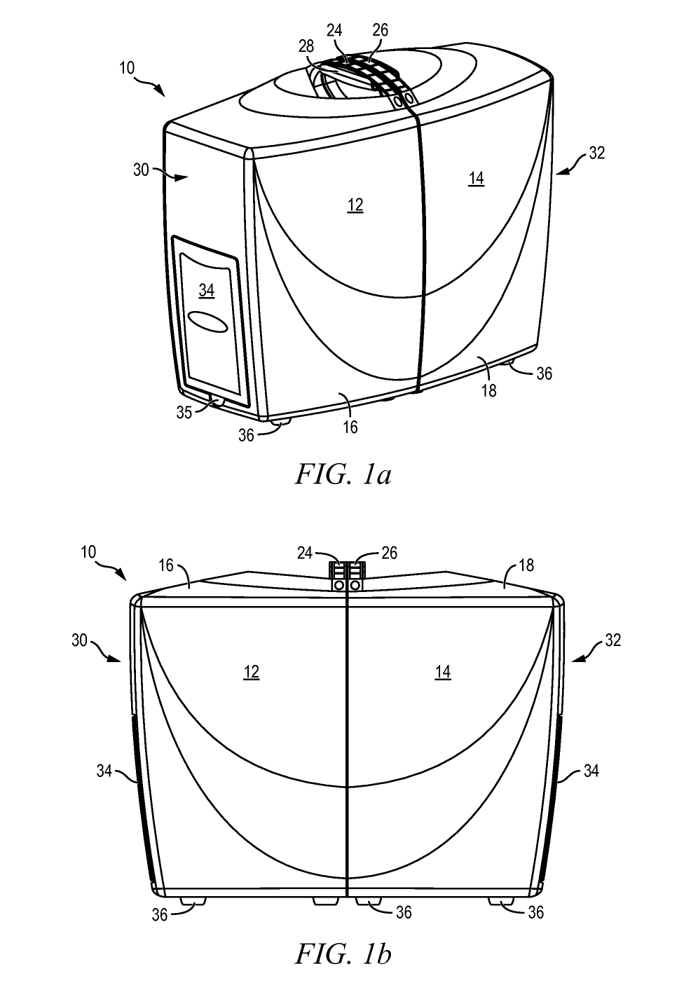

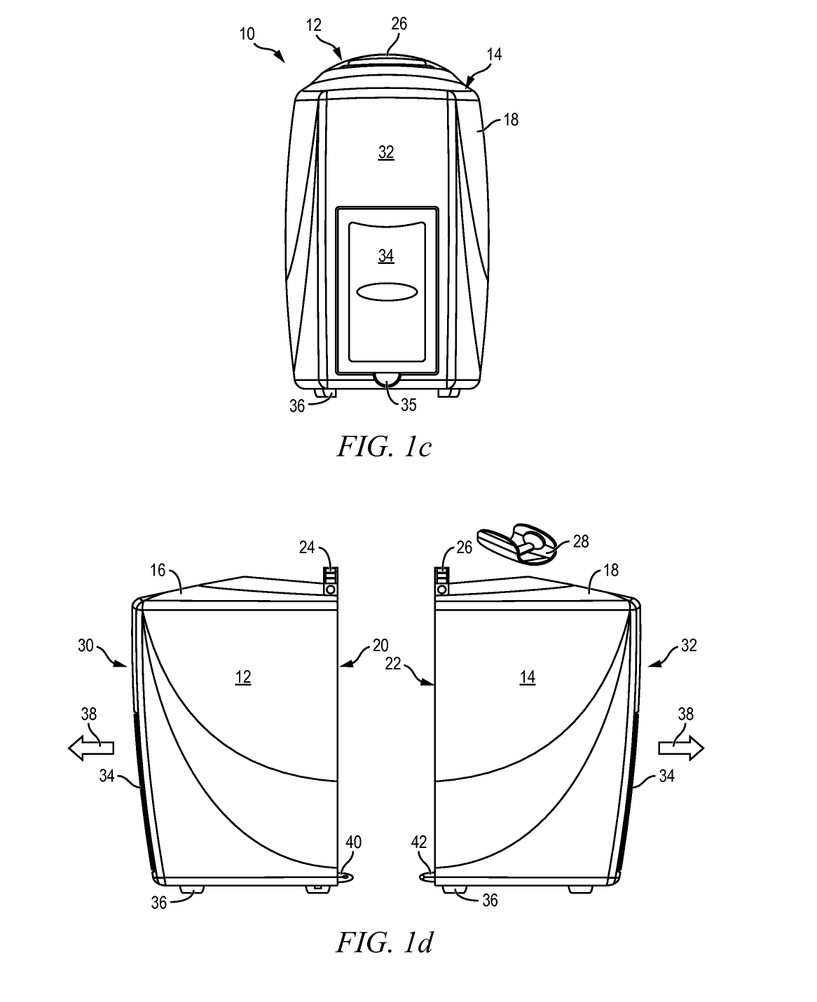

FIGS. 1a-1c illustrate a portable studio monitor system 10 in a travel mode. FIG. 1a illustrates a perspective view of monitor system 10. Monitor system 10 includes a master monitor or speaker 12 and a remote monitor or speaker 14. Master monitor 12 is secured to remote monitor 14. In travel mode, master monitor 12 and remote monitor 14 stay affixed to one another such that monitor system 10 is a single unit that can be easily carried and transported. A face of master monitor 12 is oriented toward and adjacent to a face of remote monitor 14. In travel mode, the faces of monitors 12 and 14 remain oriented toward one another and unexposed. The unexposed faces of monitors 12 and 14 are protected from being dented or damaged while in transport. Master monitor 12 includes a hard outer cabinet 16. Outer cabinet 16 houses the internal components, e.g., drivers, circuitry, etc., of monitor 12. Remote monitor 14 includes a hard outer cabinet 18. Outer cabinet 18 houses the internal components, e.g., drivers, circuitry, etc., of monitor 14. Outer cabinets 16 and 18 include plastic, synthetic resin, wood, metal, or other material having similar structural properties. Outer cabinets 16 and 18 are formed by molding, stamping, die-casting, extrusion, or other suitable manufacturing process. The material of cabinets 16 and 18 is lightweight, durable, and resistant to denting. Outer cabinets 16 and 18 provide a hard outer shell that protects the internal components of monitors 12 and 14 without adding excess weight.

A handle 24 is attached to a top surface of master monitor 12. A handle 26 is attached to a top surface of remote monitor 14. Handles 24 and 26 allow monitor system 10 to be easily carried. A groove is formed in the top surface of outer cabinets 16 and 18 below handles 24 and 26. The groove creates space for a person to easily slide his/her fingers under handles 24 and 26 and lift or carry monitor system 10. Handles 24 and 26 are configured to be in close proximity to one another, when monitor system 10 is in travel mode.

A handle grip 28 is placed over handles 24 and 26. Handle grip 28 has a “U” or concave shape and is formed to fit over both handle 24 and handle 26. Handle grip 28 is made of rubber, plastic, synthetic resin, or other durable, non-slip material. Handle grip 28 is formed by molding, stamping, extrusion, or other suitable manufacturing process. Handle grip 28 is disposed over handle 24 and handle 26 to hold the top potions of monitors 12 and 14 together. When handle grip 28 is disposed around handles 24 and 26, monitors 12 and 14 are prevented from separating. Handle grip 28 provides a sturdy, non-slip, comfortable grip. Handle grip 28 allows monitor system 10 to be comfortably and securely carried.

A distal end or backside surface 30 of master monitor 12 and a distal end or backside surface 32 of remote monitor 14 each include a removable door 34. A recess 35 is formed into the surface of outer cabinets 16 and 18 below removable door 34. Removable doors 34 cover components, e.g., input/output jacks, power switch, storage cavity, of monitor system 10.

Monitors 12 and 14 each include a plurality of feet 36 attached to a bottom surface of the monitor opposite handles 24 and 26. Feet 36 are mounted to outer cabinets 16 and 18 using screws, clips, adhesive, or other suitable mechanism. Alternatively, feet 36 are formed as part of each outer cabinet by molding, extrusion, or other suitable manufacturing process. Feet 36 include a rubber, plastic, synthetic resin, or other sturdy material. Feet 36 support and stabilize monitors 12 and 14. When monitor system 10 is placed on the ground or other surface, feet 36 create a clearance between the bottom surface of monitors 12 and 14 the surface on which monitors 12 and 14 are placed. Monitor system 10 is raised above and protected from puddles or other harmful substances on the ground or surface supporting monitor system 10.

FIG. 1b illustrates a side view of monitor system 10. An edge of outer cabinet 16 surrounds the face of master monitor 12, and contacts an edge of outer cabinet 18 that surrounds the face remote monitor 14. In travel mode, the edge of outer cabinet 16 stays in contact with the edge of outer cabinet 18 to seal off the faces of monitors 12 and 14. Outer cabinets 16 and 18 provide a protective covering around the circuitry and drivers of monitors 12 and 14. The protective covering provided by outer cabinets 16 and 18 prevents water, dust, etc., from reaching the faces and/or internal circuitry of monitors 12 and 14. Outer cabinets 16 and 18 allow monitor system 10 to be transported through wind, rain, etc., without damage.

FIG. 1c illustrates backside surface 32 of remote monitor 14, which is similar to backside surface 30 of master monitor 12. Removable door 34 is attached to outer cabinet 18 of monitor 14 by magnet, hinge, or other suitable mechanism. Removable door 34 covers a storage cavity that is formed in back surface 32 of outer cabinet 18. Removable door 34 remains attached to outer cabinet 18 while monitor system 10 is in travel mode to secure items stored in the cavity and protect the components behind removable door 34 from damage. Recess 35 is formed into the surface of outer cabinet 18 below removable door 34. Recess 35 provides a point of access to pull removable door 34 away from monitor 14 and access the components located behind removable door 34.

In FIG. 1d, monitor system 10 is opened, i.e., taken out of travel mode, to expose the faces of monitors 12 and 14. Handle grip 28 is removed from over handles 24 and 26. A force is applied to monitors 12 and 14 in the direction of arrows 38 to pull monitors 12 and 14 apart. Monitors 12 and 14 separate when the force in the direction of arrows 38 exceeds a force necessary to disengage a securing assembly 40 of master monitor 12 from remote monitor 14 and a securing assembly 42 of remote monitor 14 from master monitor 12. Pulling the monitors 12 and 14 apart exposes a baffle 20 of master monitor 12 and a baffle 22 of remote monitor 14.

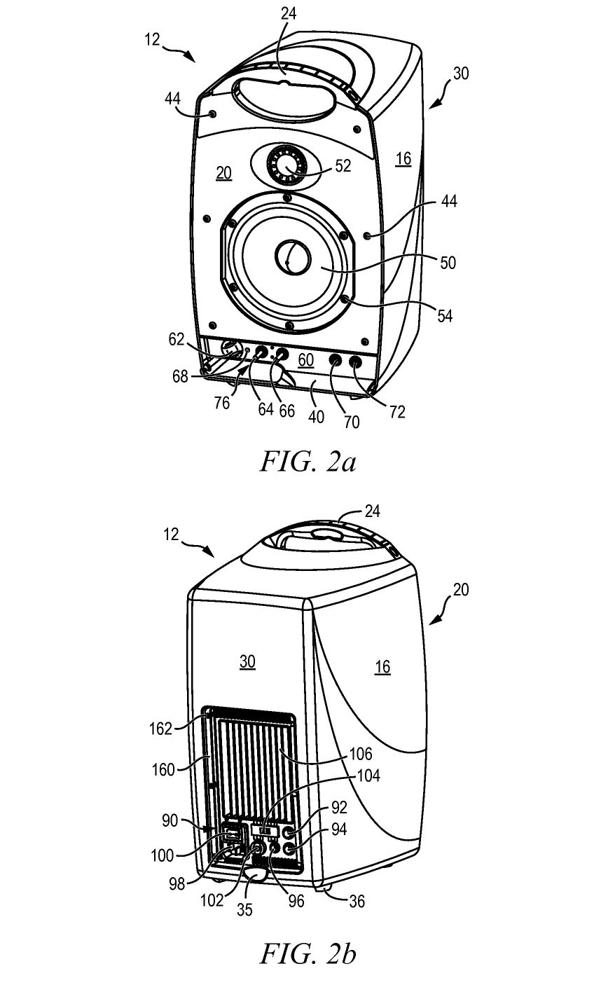

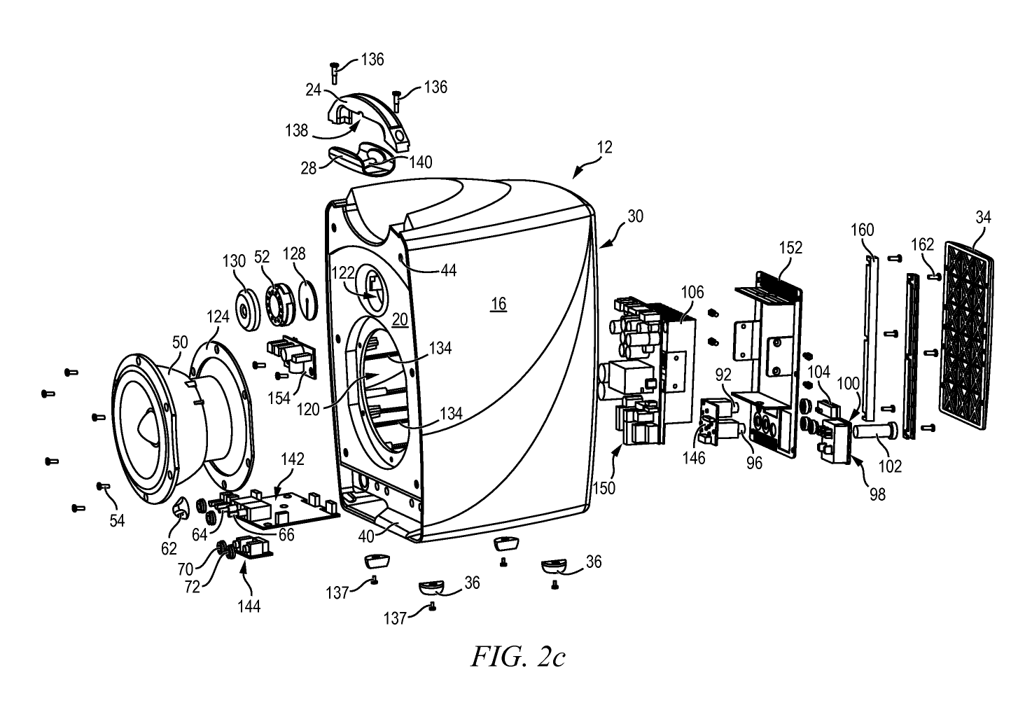

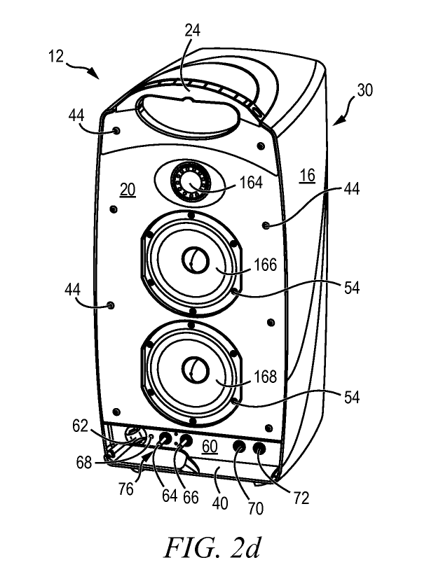

FIGS. 2a and 2b show a perspective front view and a perspective back view, respectively, of master monitor 12. As shown in FIG. 2a, master monitor 12 includes baffle 20 disposed over outer cabinet 16. Baffle 20 includes plastic, synthetic resin, wood, metal, or other material having similar structural properties. Baffle 20 is formed by molding, stamping, extrusion, die-casting, or other suitable manufacturing process. Screws 44 secure baffle 20 to outer cabinet 16. Handle 24 is attached to the top surface of outer cabinet 16. A woofer or low frequency driver 50 and a tweeter or high frequency driver 52 are mounted to baffle 20. Screws 54 are used to attach woofer 50 to baffle 20. Woofer 50 is connected to circuitry within master monitor 12. Woofer 50 receives low frequency electronic signals and converts the low frequency electronic signal to mechanical air movement, i.e., sound waves. In one embodiment, woofer 50 has a frequency a range of approximately 50 Hz to 2,500 Hz. Tweeter 52 is connected to circuitry within master monitor 12. Tweeter 52 receives high frequency electronic signals and converts the high frequency electronic signal to mechanical air movement, i.e., sound waves. In one embodiment, tweeter 52 has a frequency range of approximately 2,000 Hz to 20,000 Hz. Tweeter 52 can be a cone tweeter, dome tweeter, piezo tweeter, ribbon tweeter, air motion transformer (AMT) tweeter, or other high frequency driver. In one embodiment, tweeter 52 is an inverted dome tweeter.

Baffle 20, woofer 50, tweeter 52, and outer cabinet 16 seal off and provide a protective covering around the circuitry within master monitor 12. The protective covering provided by baffle 20, woofer 50, tweeter 52, and outer cabinet 16 prevents dust, water, and other harmful substances from damaging the internal circuitry of monitor 12. Baffle 20, woofer 50, and tweeter 52 are configured such that when monitor system 10 is in travel mode, as shown in FIGS. 1a-1c, baffle 20 of monitor 12 is flush with baffle 22 of monitor 14 and outer cabinet 16 is in contact with outer cabinet 18 to seal off the faces of monitors 12 and 14.

A front control panel 60 is mounted to outer cabinet 16 below baffle 20 using screws, clips, adhesive, or other securing mechanism. Alternatively, control panel 60 is formed as part of outer cabinet 16 by molding, extrusion, or other suitable manufacturing process. Control panel 60 supports control knobs and switches that allow a user to monitor and manually control various settings of monitor system 10. A volume knob 62 on front panel 60 is connected to a potentiometer within master monitor 12 and allows the user to increase and decrease an overall audio output volume of monitor system 10. A bass control switch 64 on front panel 60 is connected to circuitry within master monitor 12 and allows the user to control an amplification or attenuation of the bass, i.e., low frequency, output of monitors 12 and 14. In one embodiment, bass control switch 64 modifies frequencies less than or equal to 75 Hz. A treble control switch 66 on front panel 60 is connected to circuitry within master monitor 12 and allows the user to amplify or attenuate the treble, i.e., high frequency, output of monitors 12 and 14. In one embodiment, treble control switch 66 modifies frequencies greater than or equal to 7,500 Hz.

Front panel 60 includes a power/clipping indicator display 68. Indicator display 68 includes light emitting diodes (LEDs) of various color. The LEDs of indicator display 68 are connected to circuitry within master monitor 12 and alert the user of monitor system 10 to various operating conditions of monitor system 10. For example, when power is supplied to monitor system 10 a green LED is illuminated indicating to the user that monitor system 10 is turned-on, or for example, when monitor system 10 is experiencing clipping a red LED is illuminated indicating to the user that a volume level of monitor system 10 should be decreased to prevent distortion of the sound output from monitor system 10.

Front control panel 60 also supports an audio input jack 70 and a headphones jack 72. Input jack 70 is connected to circuitry within monitor 12. Input jack 70 is configured to receive audio cables and couple monitor system 10 to an audio signal source. Jack 72 is connected to circuitry within monitor 12. Jack 72 is configured to receive audio cables and couple a set of headphones to monitor system 10. Plugging headphones into jack 72 routes audio signals to the headphones and mutes sound output from monitors 12 and 14.

A securing assembly 40 and a cavity 76 are formed below control panel 60. Securing assembly 40 is mounted to outer cabinet 16 using screws, clips, adhesive or other securing mechanism. Alternatively, securing assembly 40 is formed as part of outer cabinet 16 by molding, extrusion, or other suitable manufacturing process. Securing assembly 40 protrudes from monitor 12. Securing assembly 40 extends from a vertical plane corresponding to the face of monitor 12 away from outer cabinet 16. Securing assembly 40 is configured to mate with a cavity formed in the face of remote monitor 14. Cavity 76 is formed adjacent to securing assembly 40. Cavity 76 extends from the vertical plane corresponding to the face of master monitor 12 into outer cabinet 16. Cavity 76 is configured to receive securing assembly 42 of remote monitor 14. When monitor system 10 is in travel mode, as shown in FIGS. 1a-1c, securing assembly 40 extends into remote monitor 14, and cavity 76 receives securing assembly 42 of remote monitor 14. Securing assembly 40 and cavity 76 are configured such that when securing assembly 40 is extended into remote monitor 14 and cavity 76 receives securing assembly 42, i.e., when monitor system 10 is in travel mode, baffle 20 of master monitor 12 is flush with baffle 22 of remote monitor 14 and outer cabinet 16 is in contact with outer cabinet 18.

Referring to FIG. 2b, removable door 34 is detached from monitor 12 to expose an opening in surface 30 of outer cabinet 16. The opening in surface 30 exposes a rear control panel 90 and a heatsink 106 attached to circuitry within monitor 12. Rear panel 90 includes a left balance audio input jack 92 and a right balance audio input jack 94. Input jacks 92 and 94 are connected to circuitry within monitor 12. Input jacks 92 and 94 are configured to receive audio cables and couple master monitor 12 to an audio signal source. An audio output jack 96 is included on panel 90 and connected to circuitry within monitor 12. Audio output jack 96 is configured to receive audio cables and output audio signals from circuitry within master monitor 12 to remote monitor 14. Panel 90 includes a power supply input 98 and an on/off switch 100. Power supply input 98 is configured to receive a power cord and draw upon a source of alternating current (AC) to power monitor system 10. On/off switch 100 is configured to supply power to monitor system 10 when switch 100 is in an on position, and cease supplying power to monitor system 10 when switch 100 is in an off position. A fuse 102 is also included on panel 90. Fuse 102 provides overcurrent protection. A voltage selector 104 on panel 90 allows the user to control a voltage setting of monitor system 10. Heatsink 106 is coupled to a printed circuit board (PCB) housed within master monitor 12. Heatsink 106 dissipates heat from the PCB and increases the thermal efficiency of monitor system 10.

FIG. 2c illustrates an exploded view of master monitor 12. Outer cabinet 16 of master monitor 12 is formed with a hollow structure. The hollow structure of outer cabinet 16 reduces a weight of master monitor 12 and makes monitor system 10 lighter and more convenient to carry. Internal sidewalls of outer cabinet 16 include ribs 134. Ribs 134 are formed horizontally along the sidewalls of outer cabinet 16 to increase the bending stiffness of outer cabinet 16 and minimize flexing during use. Ribs 134 stiffen and strengthen outer cabinet 16. Ribs 134 make outer cabinet 16 resistant to denting. Stiffer sidewalls prevent baffle 20, woofer 50, tweeter 52, and circuitry within master monitor 12 from being damaged if monitor 12 is dropped or banged into. Ribs 134 increase the bending stiffness, strength, and durability of outer cabinet 16 without adding excessive weight to master monitor 12. The increased strength provided by ribs 134 allows a thickness of the sidewalls of outer cabinet 16 to be reduced Thinner outer cabinet sidewalls decrease a weight of master monitor 12 and an overall weight of monitor system 10.

Outer cabinet 16 is formed with an open face. Baffle 20 is disposed over the open face of outer cabinet 16 and secured to outer cabinet 16 using screws 44. Baffle 20 supports the drivers, e.g., woofer 50 and tweeter 52, of master monitor 12. A circular opening 120 is formed completely through baffle 20. Opening 120 receives woofer 50. A recess 122 is formed in the surface of baffle 20 over opening 120. Recess 122 receives and supports tweeter 52. A ring shaped foam gasket 124 is disposed between baffle 20 and woofer 50. Screws 54 secure woofer 50 and foam gasket 124 to a recessed lip formed around opening 120. A circular foam gasket 128 is placed in recess 122. Tweeter 52 is secured, mounted, or otherwise disposed in recess 122 over foam gasket 124 using friction coupling, adhesive, screws, or other suitable attachment mechanism. A grill 130 is secured, mounted, or otherwise disposed in recess 122 over tweeter 52 using friction coupling, adhesive, screws, or other suitable attachment mechanism. The depth of recess 122 is selected to allow a surface of grill 130 to be substantially coplanar with the surface of baffle 20.

Handle 24 is secured over a top surface of outer cabinet 16 using screws 136. Feet 36 are secured to a bottom surface of outer cabinet 16 using screws 137. Handle 24 includes a groove 138. Groove 138 is concave and is formed in a surface of handle 24 that is oriented toward the top surface of outer cabinet 16. A protrusion 140 is formed on handle grip 28. Protrusion 140 is convex and is formed on a surface of handle grip 28 that is oriented toward handle 24. Groove 138 is configured to mate with protrusion 140. When handle grip 28 is placed over handle 24 (and handle 26 of remote monitor 14), protrusion 140 rests within groove 138. Protrusion 140 seated or disposed in groove 138 prevents handles 24 and 26 and monitors 12 and 14 from shifting or sliding horizontally. Protrusion 140 and groove 138 keep the top portions of monitors 12 and 14 aligned and securely in place. Protrusion 140 disposed in groove 138 also prevents handle grip 28 from slipping or sliding. Handle 24 and handle grip 28 increase the ease with which monitor system 10 can be carried and transported.

A pre-amplification (pre-amp) PCB 142 and an input/output jack PCB 144 are secured, mounted, or otherwise disposed within outer cabinet 16 of master monitor 12 proximate to front panel 60. Volume knob 62 is coupled to a potentiometer included on pre-amp PCB 142. Bass control switch 64, treble control switch 66, and indicator display 68 are coupled to circuitry included on pre-amp PCB 142. Audio input jack 70 and headphones jack 72 are coupled to circuitry on PCB 144. PCB 144 is coupled to pre-amp PCB 142 such that audio signals are routed between input jack 70 and headphone jack 72 and circuitry on pre-amp PCB 142.

An input/output jack PCB 146 and a PCB 150 are secured, mounted, or otherwise disposed in outer cabinet 16 proximate to panel 90. PCB 150 includes a switch mode power supply (SMPS) and digital amplifier (DAMP) circuitry. Heatsink 106 is coupled to PCB 150. Heatsink 106 dissipates heat from PCB 150 and increases the thermal efficiency of monitor system 10. PCB 150 and PCB 146 are secured to a chassis 152. Chassis 152 is mounted or secured to outer cabinet 16. Chassis 152 supports PCB 150, PCB 146, heatsink 106, and the components of panel 90, i.e., left balance input jack 92, right balance input jack 94, audio output jack 96, power supply input 98, on/off switch 100, fuse 102, and voltage selector 104. Power supply input 98, on/off switch 100, fuse 102, and voltage selector 104 are each coupled to circuitry on PCB 150.

Left balance input jack 92, right balance input jack 94, and audio output jack 96 are coupled to circuitry included on PCB 146. PCB 146 is coupled to pre-amp PCB 142. Output signals from left balance input jack 92 and right balance input jack 94 are routed from PCB 146 to pre-amp PCB 142. Pre-amp PCB 142 is coupled to PCB 150. Output signals from pre-amp PCB 142 are routed to amplification circuitry on PCB 150. PCB 150 is coupled to output jack 96 on PCB 146. Output signals from the amplification circuitry on PCB 150 are routed through PCB 146 and output jack 96 to remote monitor 14.

A speaker interconnect PCB 154 is secured, mounted, or otherwise disposed within outer cabinet 16 of master monitor 12 proximate to woofer 50 and tweeter 52. Woofer 50 and tweeter 52 are coupled to circuitry on speaker interconnect PCB 154. Speaker interconnect PCB 154 is coupled to circuitry of PCB 150. Speaker interconnect PCB 154 routes output signals from the amplification circuitry on PCB 150 to woofer 50 and tweeter 52. Woofer 50 and tweeter 52 convert the signals received from PCB 154 into sound waves.

Rails 160 are secured to back surface 30 of outer cabinet 16 using screws 162. Rails 160 are disposed around the opening in back surface 30 that exposes control panel 90 and heatsink 106. Removable door 34 attaches to rails 160 to cover panel 90 and heatsink 106 when monitor system 10 is in travel mode. Removable door 34 detaches from rails 160 to provide access to panel 90 when monitor system 10 is in operation. Removable door 34 is secured to rails 160 by way of a magnetic coupling. In one embodiment, removable door 34 contains magnets, or is magnetically charged, with a first polarity, e.g., positive polarity. In a similar manner, rails 160 are neutral metal or magnetically charged with a second polarity that is opposite to the first polarity, e.g., negative polarity. When removable door 34 is placed in close proximity to rails 160, the magnetic force between the opposing attractive polarities causes removable door 34 to be attached or held to rails 160. To access rear control panel 90, a force is applied to removable door in a direction away from panel 90. When the force applied to removable door 34 exceeds the magnetic force between removable door 34 and rails 160, removable door separates from rails 160 and panel 90 is accessible. Alternatively, removable door 34 employs a hinge or other suitable mechanism that allows removable door to cover panel 90 when monitor system 10 is in travel mode and grant access to back panel 90 when monitor system 10 is in use.

In another embodiment, shown in FIG. 2d, master monitor 12 includes a high frequency driver 164 having a frequency range of approximately 3,000 Hz to 20,000 Hz, a mid-range frequency driver 166 having a frequency range of approximately 100 Hz to 5000 Hz, and a low frequency driver 168 having a frequency of approximately 20 Hz to 250 Hz. Drivers 164-168 are secured to baffle 20 using friction coupling, screws 54, clips, adhesive, or other suitable attachment mechanism. Drivers 164-168 convert electric signals received from circuitry within master monitor 12 into sound waves.

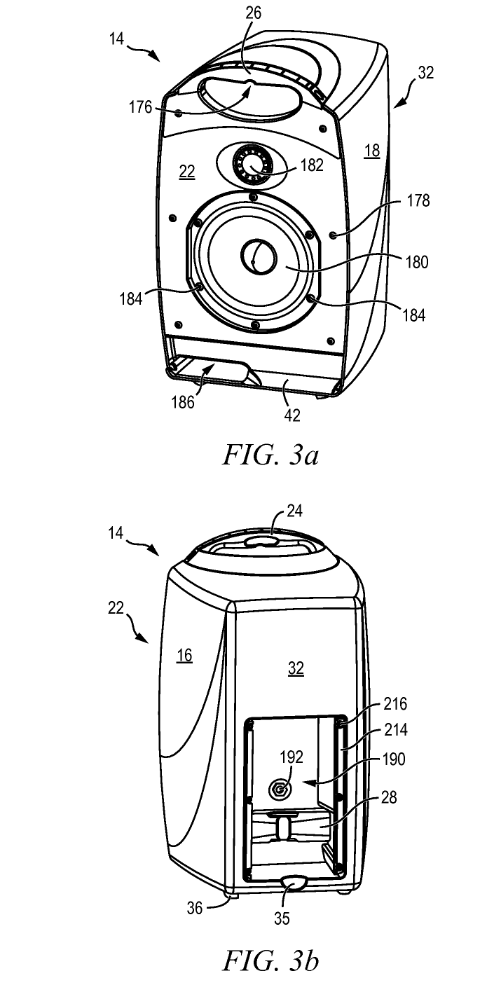

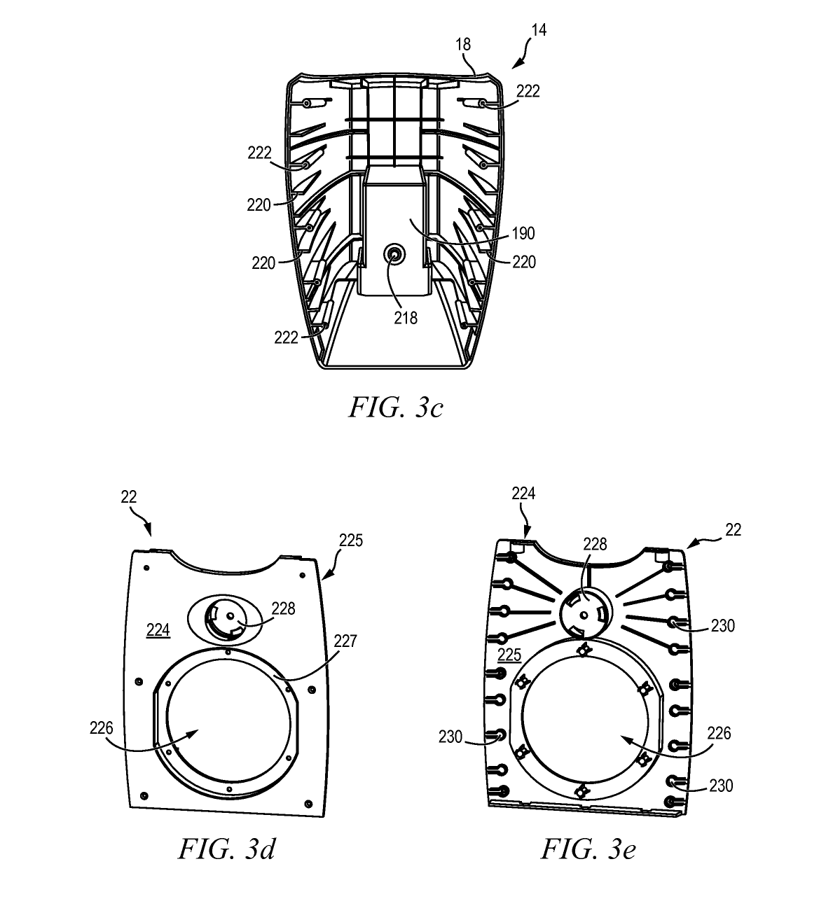

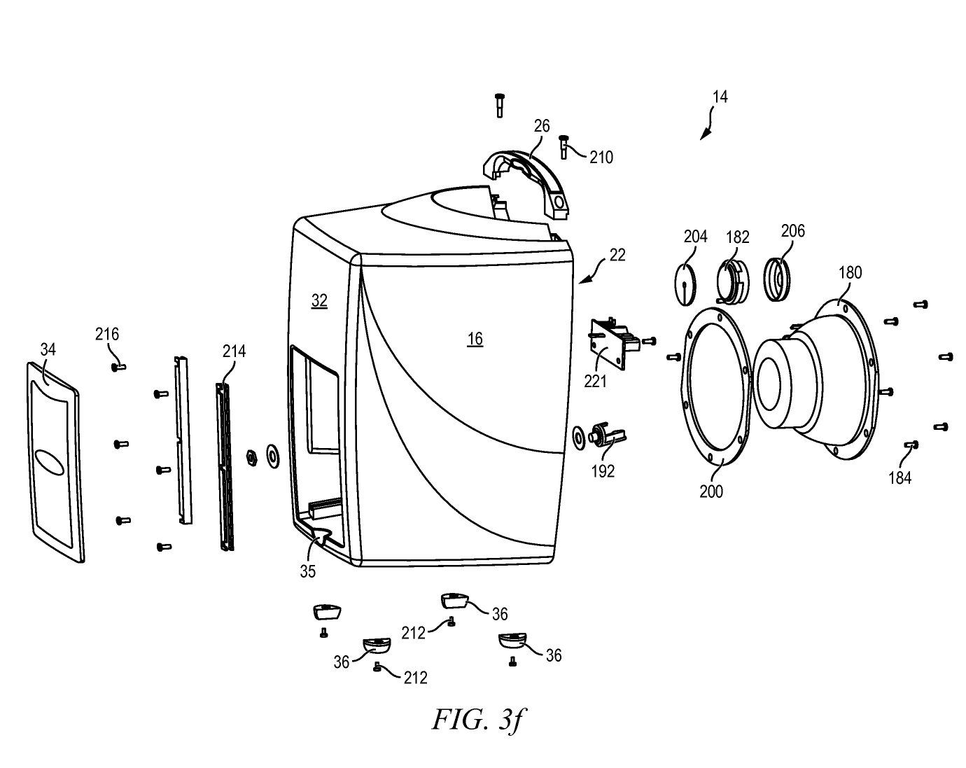

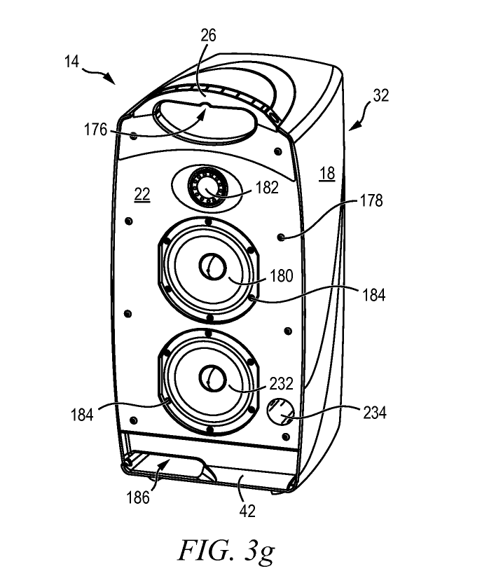

FIGS. 3a and 3b show a perspective front view and a perspective back view, respectively, of remote monitor 14. As shown in FIG. 3a, remote monitor 14 includes outer cabinet 18. Handle 26 is attached to a top surface of outer cabinet 18. Handle 26 includes a groove 176. Groove 176 is concave and is formed in a surface of handle 26 that is oriented toward the top surface of outer cabinet 18. Groove 176 aligns with groove 138 on handle 24 of master monitor 12 when monitor system 10 is in travel mode. Groove 176 is configured to mate with protrusion 140 on handle grip 28. When monitor system 10 is in travel mode, grip 28 is disposed around handle 24 of master monitor 12 and handle 26 of remote monitor 14, and protrusion 140 rests within grooves 138 and 176. Protrusion 140 in grooves 138 and 176 prevents handles 24 and 26 and monitors 12 and 14 from shifting or sliding horizontally. Protrusion 140 and grooves 138 and 176 keep the top portions of monitors 12 and 14 aligned and securely in place. Protrusion 140 disposed in grooves 138 and 176 also prevents grip 28 from slipping or sliding. Handle 26, in concert with handle 24 and handle grip 28, increases the ease with which monitor system 10 can be carried and transported.

Baffle 22 is disposed over outer cabinet 18. Screws 178 secure baffle 22 to outer cabinet 18. A woofer or low frequency driver 180 and a tweeter or high frequency driver 182 are mounted to baffle 22. Screws 184 secure woofer 180 to baffle 22. Woofer 180 is connected to circuitry within remote monitor 14 and master monitor 12. Woofer 180 receives low frequency electronic signals and converts the low frequency electronic signal to mechanical air movement, i.e., sound waves. Woofer 180 has a frequency range of approximately 20 Hz to 5,000 Hz. Tweeter 182 is connected to circuitry within remote monitor 14 and master monitor 12. Tweeter 182 receives high frequency electronic signals and converts the high frequency electronic signal to mechanical air movement, i.e., sound waves. Tweeter 182 has a frequency range of approximately 3,000 Hz to 20,000 Hz. Tweeter 182 can be a cone tweeter, dome tweeter, piezo tweeter, ribbon tweeter, air motion transformer (AMT) tweeter, or other high frequency driver. In one embodiment, tweeter 182 is an inverted dome tweeter.

Baffle 22, woofer 180, tweeter 182, and outer cabinet 18 seal off and provide a protective covering around the circuitry within remote monitor 14. The protective covering provided by baffle 22, woofer 180, tweeter 182, and outer cabinet 18 prevents dust, water, and other harmful substances from damaging the internal circuitry of monitor 14. Baffle 22, woofer 180, and tweeter 182 are configured such that when monitor system 10 is in travel mode, as shown in FIGS. 1a-1c, baffle 22 of monitor 14 is flush with baffle 20 of monitor 12 and outer cabinet 18 is in contact with outer cabinet 16 to seal off the faces of monitors 14 and 12.

A securing assembly 42 and a cavity 186 are formed below baffle 22 proximate to a bottom surface of outer cabinet 18. Securing assembly 42 is mounted to outer cabinet 18 using screws, clips, adhesive or other securing mechanism. Alternatively, securing assembly 42 is formed as part of outer cabinet 18 by molding, extrusion, or other suitable manufacturing process. Securing assembly 42 protrudes from remote monitor 14. Securing assembly 42 extends from a vertical plane corresponding to the face of monitor 14 away from outer cabinet 18. Securing assembly 42 is configured to mate with cavity 76 of master monitor 12. Cavity 186 is adjacent to securing assembly 42. Cavity 186 extends from the vertical plane corresponding to the face of remote monitor 14 into outer cabinet 18. Cavity 186 is configured to receive securing assembly 40 of master monitor 12. When monitor system 10 is in travel mode, as shown in FIGS. 1a-1c, securing assembly 42 extends into cavity 76 of master monitor 12, and cavity 186 receives securing assembly 40 of master monitor 12. Securing assembly 42 and cavity 186 are configured such that when securing assembly 42 is extended into cavity 76 and cavity 186 receives securing assembly 40, i.e., when monitor system 10 is in travel mode, baffle 22 of remote monitor 14 is flush with baffle 20 of master monitor 12 and outer cabinet 18 is in contact with outer cabinet 16.

Referring to FIG. 3b, removable door 34 is detached from monitor 14 to expose a rear cavity 190. Rear cavity 190 is formed in back surface 32 of outer cabinet 18. An input jack 192 extends through a back wall of cavity 190. Input jack 192 is configured to receive an audio cable carrying audio signals output from jack 96 on panel 90 of master monitor 12. Cavity 190 provides a storage space. When monitor system 10 is in travel mode, removable door 34 is closed over cavity 190 and audio cables, power cables, recording accessories, etc., can be stored in cavity 190. As shown in FIG. 2b, when monitor system 10 is not in travel mode, handle grip 28 can be stored in cavity 190.

FIG. 3c shows outer cabinet 18 of remote monitor 14. Cavity 190 extends from back surface 32 of monitor 14 into cabinet 18. An opening 218 is formed in the back wall of cavity 190 to support input jack 192. Outer cabinet 18 is formed with a hollow structure and an open face similar to cabinet 16. The hollow structure of outer cabinet 18 reduces a weight of remote monitor 14 and makes monitor system 10 lighter and more convenient to carry. Internal sidewalls of outer cabinet 18 include ribs 220. Ribs 220 are similar to ribs 134 in outer cabinet 16. Ribs 220 are formed horizontally along the sidewalls of outer cabinet 18 to increase the bending stiffness of outer cabinet 18 and minimize flexing during use. Ribs 220 stiffen and strengthen outer cabinet 18. Ribs 220 make outer cabinet 18 resistant to denting. Stiffer sidewalls prevent baffle 22, woofer 180, tweeter 182, and circuitry within remote monitor 14 from being damaged if monitor 14 is dropped or banged into. Ribs 220 increase the bending stiffness, strength, and durability of outer cabinet 18 without adding excessive weight to remote monitor 14. The increased strength provided by ribs allows a thickness of the sidewalls of outer cabinet 18 to be reduced. Thinner outer cabinet sidewalls decrease a weight of remote monitor 14 and an overall weight of monitor system 10. A plurality of screw receptacles 222 are formed in select ribs 220. Receptacles 222 receive screws 178 to secure baffle 22 to outer cabinet 18. Select ribs 134 of outer cabinet 16 include similar receptacles for receiving screws 44.

FIGS. 3d and 3e show baffle 22 of remote monitor 14, which is similar to baffle 20 of master monitor 12. Baffle 22 supports the drivers, e.g., woofer 180 and tweeter 182, of remote monitor 14. Baffle 22 includes plastic, synthetic resin, wood, metal, or other material having similar structural properties. Baffle 22 is formed by molding, stamping, extrusion, or other suitable manufacturing process. Baffle 22 includes opposing surfaces 224 and 225. An opening 226, similar to opening 120 of baffle 20, is formed through baffle 22. Opening 226 extends completely through baffle 22 from surface 224 to surface 225. A lip 227 is formed around opening 226. Lip 227 is recessed, or on a different vertical plane, from surface 224 of baffle 20. When woofer 180 is disposed in opening 226, an outer rim of woofer 180 is secured to lip 227 using screws 184. Recessing lip 227 allows a surface of woofer 180 to be substantially planar with surface 224 of baffle 22. A recess 228, similar to recess 122 of baffle 20, is formed in surface 224 of baffle 22 to receive and support tweeter 182. Recess 122 extends into surface 224 and protrudes from surface 225 of baffle 22.

As shown in FIG. 3e, surface 225 of baffle 22 includes raised portions 230. Raised portions 230 extend orthogonally from surface 225 of baffle 22. Raised portions 230 are configured to fit around ribs 220 and receptacles 222 of outer cabinet 18. Raised portions 230 slide over ribs 220 when baffle 22 is affixed to cabinet 18. Raised portions 230 reinforce ribs 220 and aid in stiffening outer cabinet 18.

FIG. 3f illustrates an exploded view of remote monitor 14. Baffle 22 is affixed to outer cabinet 18. Woofer 180 is disposed over opening 226 of baffle 22. A ring shaped foam gasket 200 is disposed between recessed lip 227 of baffle 22 and woofer 180. Screws 184 secure woofer 180 and foam gasket 200 to recessed lip 227 of baffle 22. A circular foam gasket 204 is placed in recess 228. Tweeter 182 is secured, mounted, or otherwise disposed in recess 228 over foam gasket 204. Tweeter 182 is affixed to baffle 22 by friction coupling, adhesive, screws, or other suitable attachment mechanism. A grill 206 is secured, mounted, or otherwise disposed in recess 122 over tweeter 52 using friction coupling, adhesive, screws, or other suitable attachment mechanism. The depth of recess 228 is selected to allow a surface of grill 206 to be substantially coplanar with the surface of baffle 22.

Handle 26 is secured to outer cabinet 18 using screws 210. Feet 36 are secured to the bottom surface of outer cabinet 18 using screws 212. Rails 214 are secured to back surface 32 of outer cabinet 18 using screws 216. Rails 214 are disposed around cavity 190. Removable door 34 attaches to rails 214 to cover cavity 190 when monitor system 10 is in travel mode. Removable door 34 detaches from rails 214 to provide access to audio input jack 192 when monitor system 10 is in operation. Removable door 34 is secured to rails 214 by way of a magnetic coupling. In one embodiment, removable door 34 contains magnets, or is magnetically charged, with a first polarity, e.g., positive polarity. In a similar manner, rails 214 are neutral metal or magnetically charged with a second polarity that is opposite to the first polarity, e.g., negative polarity. When removable door 34 is placed in close proximity to rails 214, the magnetic force between the opposing attractive polarities causes removable door 34 to be attached or held to rails 214. To access cavity 190 and input jack 192, a force is applied to removable door 34 in a direction away from surface 32. When the force applied to removable door 34 exceeds the magnetic force between removable door 34 and rails 214, removable door separates from rails 214 and cavity 190 is accessible. Alternatively, removable door 34 employs a hinge or other suitable mechanism that allows removable door 34 to cover cavity 190 when monitor system 10 is in travel mode and grant access to cavity 190 and input jack 192 when monitor system 10 is in use.

A speaker interconnect PCB 221 is secured, mounted, or otherwise disposed within remote monitor 14 proximate to woofer 180 and tweeter 182. Woofer 180, tweeter 182, and input jack 192 are coupled to circuitry on speaker interconnect PCB 221. Jack 192 is coupled to an audio cable carrying audio signals from master monitor 12. The audio signals are routed from input jack 192 to PCB 221 and from PCB 221 to woofer 180 and tweeter 182. Woofer 180 and tweeter 182 convert the audio signals received from PCB 221 into sound waves.

In another embodiment, shown in FIG. 3g, remote monitor 14 includes a subwoofer or low frequency driver 232. Subwoofer 232 is disposed in an opening in baffle 22 below woofer 180. Subwoofer 232 is secured to baffle 22 using screws 184, adhesive, friction coupling, or other suitable attachment mechanism. Subwoofer 232 converts electric signals received from circuitry within remote monitor 14 into sound waves. In one embodiment, subwoofer 232 includes a frequency range of approximately 20 Hz to 250 Hz. A tube 234 is mounted to baffle 22 to form a reflex port or vent. Tube 234 is hollow and extends into cabinet 18. Tube 234 is attached to baffle 22 using adhesive, screws, clips, friction coupling, or other suitable attachment mechanism. Alternatively, tube 234 is formed as part of baffle 22 using molding, extrusion, die-casting, or other suitable manufacturing process. The reflex port provided by tube 234 extends the frequency response of subwoofer 232 and enhances reproduction of the lowest frequencies generated by subwoofer 232. In one embodiment, remote monitor 14 includes a high frequency driver having a frequency range of approximately 3,000 Hz to 20,000 Hz, a mid-range frequency driver having a frequency range of approximately 100 Hz to 5000 Hz, and a low frequency driver having a frequency range of approximately 20 Hz to 250 Hz, similar to drivers 164-168 of master monitor 12 in FIG. 2d.

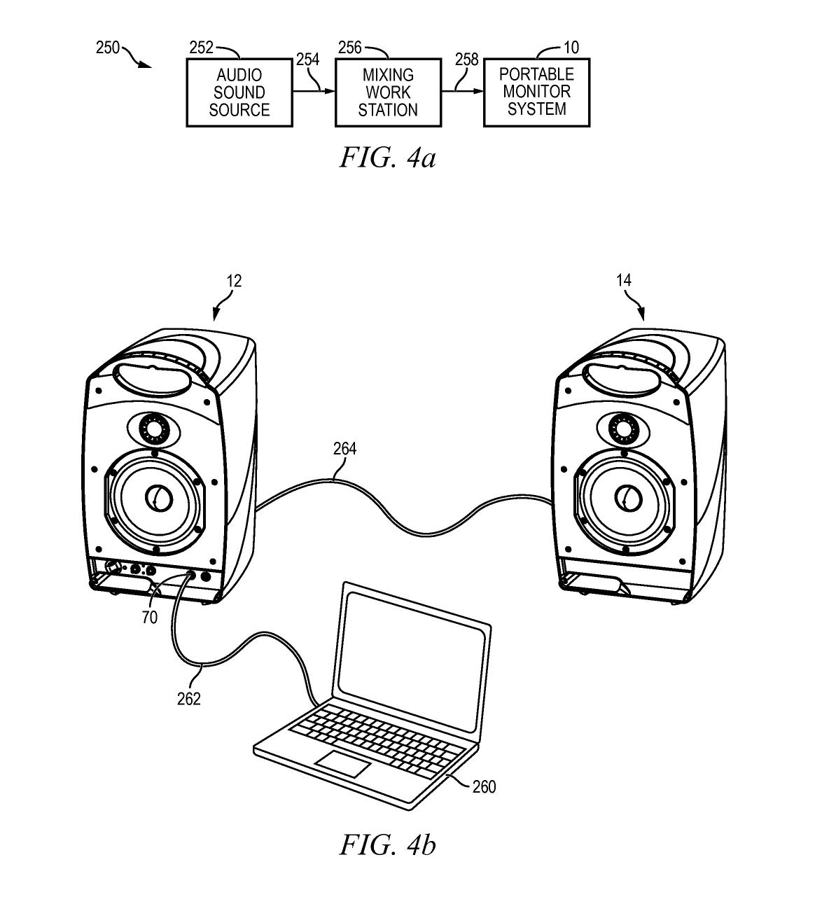

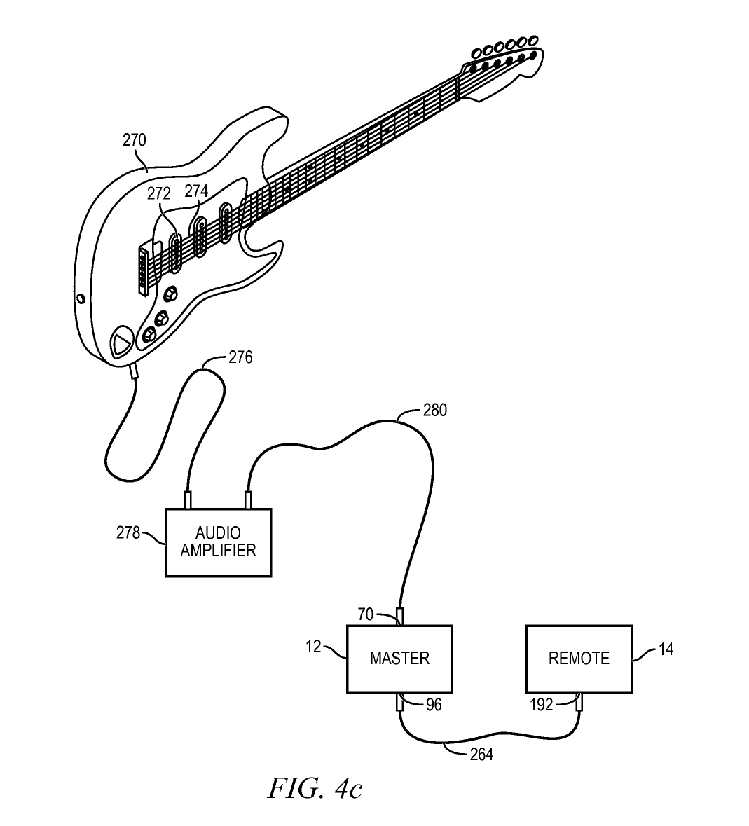

FIG. 4a illustrates an audio sound system 250 including an audio sound source 252, which generates electric signals representative of sound content. Audio sound source 252 can be a musical instrument, audio microphone, multi-media player, or other device capable of generating electric signals representative of sound content. The musical instrument can be an electric guitar, bass guitar, violin, horn, brass, drum, wind instrument, string instrument, piano, electric keyboard, or percussion instrument, just to name a few. The electrical signals from audio sound source 252 are routed through audio cable 254 to signal processing equipment or a mixing workstation 256. Multiple audio sound sources 252 can be coupled to mixing workstation 256 simultaneously or sequentially. Mixing workstation 256 is capable of recording and storing the audio signals from any number of audio sound sources 252. Mixing workstation 256 allows the user to combine, i.e., mix, live or prerecorded audio signals from one or more audio sound sources 252. Mixing workstation 256 allows the user to combine multiple audio signals and/or perform signal processing functions on the audio signals, e.g., amplification, equalization, balance, add sound effects, etc. Mixing workstation 256 can include a computer, mixing console, soundboard, signal-processing rack, audio amplifier, or other equipment or accessory capable of mixing audio signals and performing signal processing functions on the audio signals. The processed audio signals are routed from mixing workstation 256 through audio cable 258 to monitor system 10 to reproduce the sound content of audio sound sources 252 with the enhancements introduced into the audio signal by the user of mixing workstation 256.

FIG. 4b shows a computer 260 as mixing workstation 256. Monitors 12 and 14 are coupled to computer 260. Computer 260 allows the user to mix and perform signal processing functions on audio signals that are stored on computer 260. The signal processing function can include amplification, filtering, equalization, panning, sound effects, etc. The processed audio signals are routed from computer 260 through audio cable 262 to master monitor 12 and from master monitor 12 through audio cable 264 to remote monitor 14. Audio cable 262 is inserted into an output jack of computer 260 and into audio input jack 70 of master monitor 12. Alternatively, audio cable 262 is inserted into an output jack of computer 260 and into left balance input jack 92 and right balance input jack 94 on rear panel 90 of master monitor 12. Audio cable 264 is inserted into output jack 96 on rear panel 90 of master monitor 12 and into input jack 192 of remote monitor 14. Monitors 12 and 14 audibly reproduce the audio signals from computer 260. As the artist mixes and manipulates the source audio signals using computer 260, monitors 12 and 14 audibly reproduce the mixed and manipulated audio signals for recognition and appreciation by the artist. Monitors 12 and 14 provide an accurate and uncolored reproduction of the audio signals from computer 260.

FIG. 4c shows an electric guitar 270 coupled to monitors 12 and 14. One or more pickups 272 are mounted under strings 274 of electric guitar 270. Pickups convert string movement or vibration to electrical signals representative of the intended sounds from the vibrating strings. The electrical signals extend over a range or spectrum of frequencies with an amplitude associated with each frequency component. The electrical signals from guitar 270 are routed through audio cable 276 to audio amplifier 278 for signal processing and power amplification. Audio cable 276 is inserted into an output jack of guitar 270 and inserted into an input jack of audio amplifier 278. The signal conditioning provided by audio amplifier 278 includes amplification, filtering, equalization, sound effects, user-defined modules, or other signal processing functions that adjust the power level and enhance the signal properties of the audio signal. The power amplification provided by audio amplifier 278 increases or decreases the power level and signal strength of the audio signal to drive monitors 12 and 14 and reproduce the sound content intended by the vibrating strings 274 of electric guitar 270 with the enhancements introduced into the audio signal by audio amplifier 278. A front control panel of audio amplifier 278 includes a display and control knobs and buttons to allow the user to monitor and manually control various settings of the audio amplifier.

The processed audio signal is routed from audio amplifier 278 through audio cable 280 to master monitor 12 of monitor system 10 and then through audio cable 264 to remote monitor 14. Audio cable 280 is inserted into an output jack of audio amplifier 278 and into audio input jack 70 of master monitor 12. Alternatively, audio cable 280 is inserted into an output jack of audio amplifier 278 and into left balance input jack 92 and right balance input jack 94 of master monitor 12. Audio cable 264 is inserted into output jack 96 of master monitor 12 and into input jack 192 of remote monitor 14. Monitors 12 and 14 audibly reproduce the audio signal originating from guitar 270 for recognition and appreciation by an audience or listener.

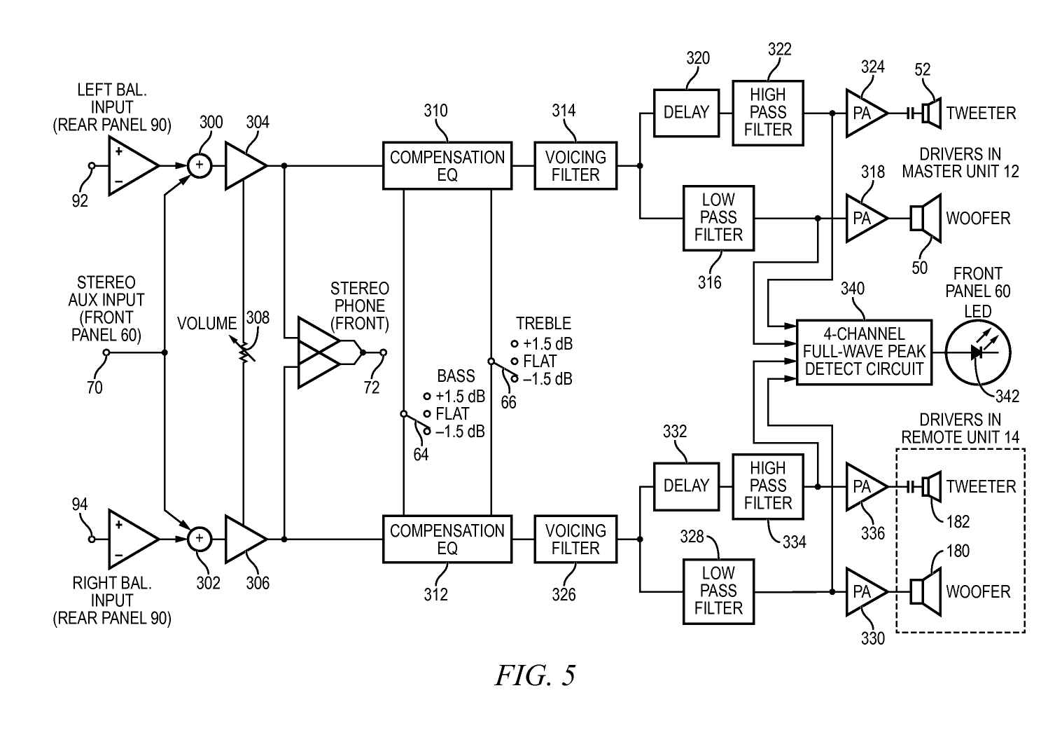

FIG. 5 illustrates a functional block diagram of monitors 12 and 14 of portable studio monitor system 10. Left balance input jack 92 and a left channel of audio input jack 70 are coupled to inputs of a summing amplifier 300. Summing amplifier 300 combines the signals from left balance input 92 and the left channel of audio input jack 70 into a single output signal. Right balance input jack 94 and a right channel of audio input jack 70 are coupled to inputs of a summing amplifier 302. Summing amplifier 302 combines the signals from right balance input 94 and the right channel of audio input jack 70 into a single output signal. The output signal from summing amplifier 300 goes through a volume control circuit 304. The output signal from summing amplifier 302 goes through a volume control circuit 306. Volume knob 62 on front control panel 60 of master monitor 12 and volume control circuits 304 and 306 are coupled to a potentiometer 308, allowing the user to control a gain of volume control circuits 304 and 306 and a loudness of audio output from monitors 12 and 14.

Output signals from volume control circuit 304 are routed to a left channel of headphone jack 72 and to a compensation equalizer 310. Output signals from volume control circuit 306 are routed to a right channel of headphone jack 72 and to a compensation equalizer 312. Compensation equalizers 310 and 312 allow the user to affect the bass and treble of the audio signal. Bass control switch 64 is coupled to compensation equalizers 310 and 312. Bass control switch 64 and compensation equalizers 310 and 312 allow the user to amplify or attenuate the bass of the audio output from monitor system 10 by 1.5 decibels (dB). Treble control switch 66 is coupled to compensation equalizers 310 and 312. Treble control switch 66 and compensation equalizers 310 and 312 allow the user to amplify or attenuate the treble of the audio output from monitor system 10 by 1.5 dB.

Output signals from compensation equalizer 310 are routed to a voicing filter 314. Output signals from voicing filter 314 are routed to a low pass filter 316. Low pass filter 316 allows low frequency signals to pass through to a power amplifier 318 and attenuates signals with frequencies higher than a designated cut-off frequency. Power amplifier 318 is coupled to woofer 50 of master monitor 12. Woofer 50 converts the electronic signal from power amplifier 318 to mechanical air movement, i.e., sound waves.

Output signals from voicing filter 314 are also routed through a delay 320 to a high pass filter 322. High pass filter 322 allows signals with high frequency signals to pass through to a power amplifier 324 and attenuates signals with frequencies lower than a designated cut-off frequency. Power amplifier 324 is coupled to tweeter 52 of master monitor 12. Tweeter 52 converts the electronic signal from power amplifier 324 to mechanical air movement, i.e., sound waves. Delay 320 keeps the output signals of high pass filter 322 and the output signals of low pass filter 316, and thus, the sound waves emanating from tweeter 52 and woofer 50 in phase.

Output signals from compensation equalizer 312 are routed to a voicing filter 326. Output signals from voicing filter 326 are routed to a low pass filter 328. Low pass filter 328 allows low frequency signals to pass through to a power amplifier 330 and attenuates signals with frequencies higher than a designated cut-off frequency. Power amplifier 330 is coupled to woofer 180 of remote monitor 14. Woofer 180 converts the electronic signals from power amplifier 330 to mechanical air movement, i.e., sound waves.

Output signals from voicing filter 326 are also routed through a delay 332 to a high pass filter 334. High pass filter 334 allows high frequency signals to pass through to a power amplifier 336 and attenuates signals with frequencies lower than a designated cut-off frequency. Power amplifier 336 is coupled to tweeter 182 of remote monitor 14. Tweeter 182 converts electronic signals from power amplifier 336 to mechanical air movement, i.e., sound waves. Delay 332 keeps the output of high pass filter 334 and the output of low pass filter 328, and thus, the sound waves emanating from tweeter 182 and woofer 180 in phase.

Output signals from low pass filter 316, output signals from high pass filter 322, output signal from low pass filter 328, and output signals from high pass filter 334 are each routed to a 4-channel full-wave peak detect circuit 340. Peak detect circuit 340 detects if the output signals from low pass filter 316, high pass filter 322, low pass filter 328, or high pass filter 334 are beyond a range or amplitude of power amplifiers 318, 324, 330, and 336, respectively. If the output signals from the high pass or low pass filters are beyond the range of the power amplifier, the power amplifier will clip or reduce the amplitude of the signal. Clipping is a form of distortion that occurs when an amplifier attempts to deliver an output voltage or current that is beyond the amplifier's maximum capability. The amplifier will amplify a signal only up to the amplifier's maximum capacity, at which point the signal is clipped. When a signal is clipped, a portion of the signal that is beyond the capability of the amplifier is cut off, resulting in a sine wave becoming a distorted square-shaped wave.

Driving an amplifier into clipping can cause all notes of an audio signal to sound equally loud because louder notes are being clipped to the same output level as softer notes. Driving an amplifier into clipping can also cause damage to the amplifier. Peak detect circuit 340 detects clipping by comparing an input signal of a power amplifier with an output signal of the power amplifier that has been adjusted for changes in applied gain. For example, if power amplifier 318 applies a gain of 10 dB, peak detect circuit 340 can test for clipping by attenuating the output signal of power amplifier 318 by 10 dB and comparing the attenuated output signal to an input signal of power amplifier 318, i.e., the output signal from low pass filter 316. If the attenuated output signal and the input signal are unequal, peak detector circuit 340 indicates that the signal is being clipped. If peak detect circuit 340 detects that power amplifier 318, 324, 330, or 336 is clipping, an LED 342 of indicator display 68 on front control panel 60 of master monitor 12 is illuminated. Once peak detect circuit 340 ceases to detect that a power amplifier is clipping, i.e., a regular shaped sine wave is being output from the power amplifier, LED 342 turns off.

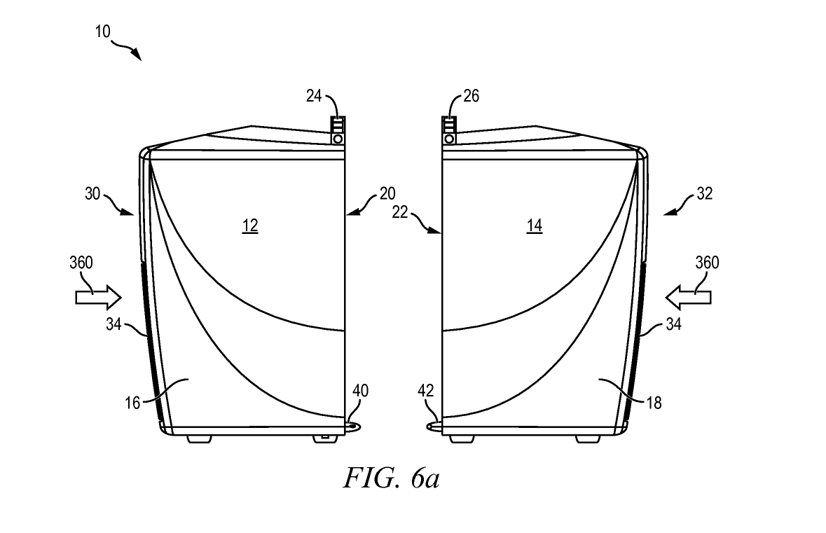

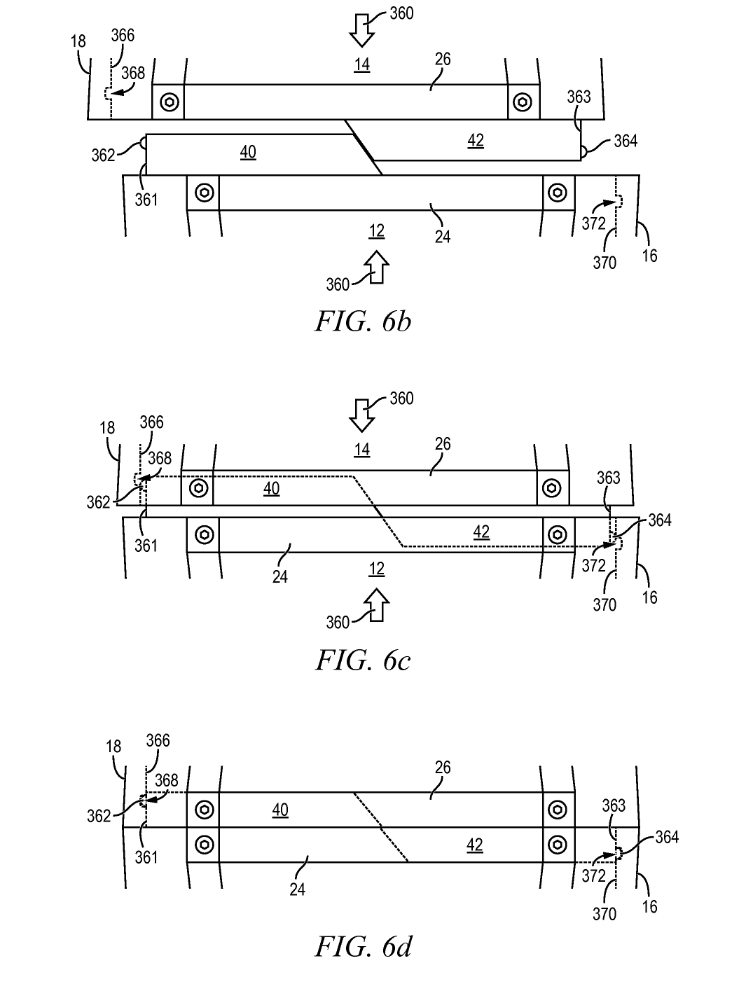

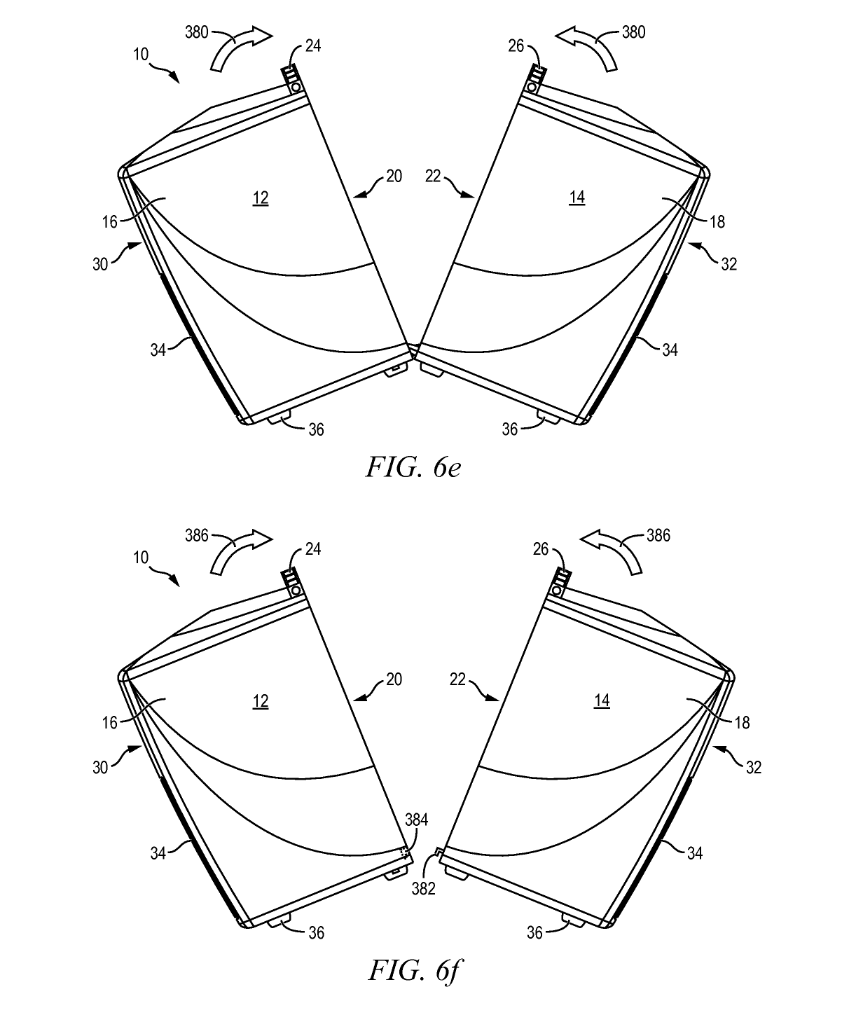

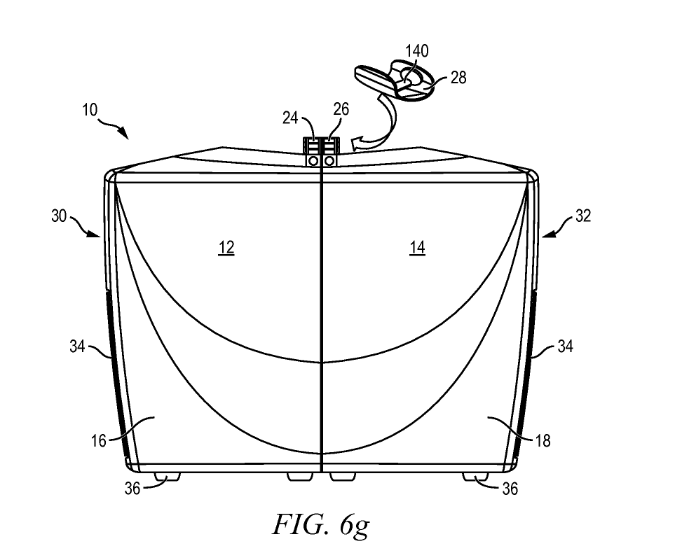

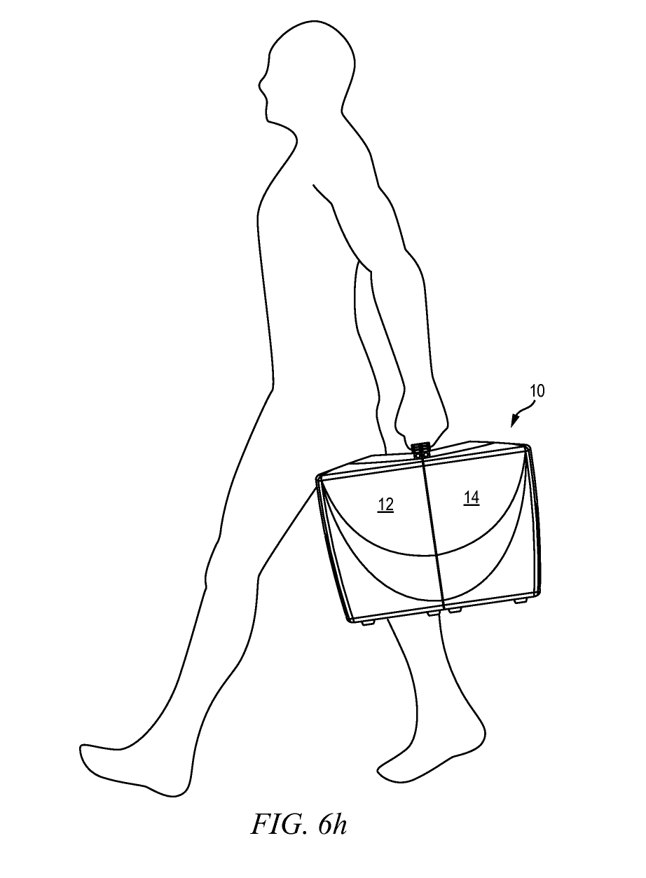

In FIG. 6a, monitors 12 and 14 are decoupled from the audio input source, e.g., mixing workstation 256 or amplifier 278, and are positioned with baffle 20 of master monitor 12 oriented toward baffle 22 of remote monitor 14. A force is applied to monitors 12 and 14 in a direction of arrows 360 to push the monitors together and place monitor system 10 is in travel mode.

FIGS. 6b-6d illustrate a plan view of monitors 12 and 14 coming together. As shown in FIG. 6b, securing assembly 40 of master monitor 12 includes a bump 362. Bump 362 is convex and is formed on surface 361 of securing assembly 40. Surface 361 and bump 362 are oriented toward an inner surface 366 of outer cabinet 18 of remote monitor 14. Bump 362 is oriented away from securing assembly 42 of remote monitor 14. Securing assembly 42 of remote monitor 14 includes a bump 364. Bump 364 is convex and is formed on surface 363 of securing assembly 42. Bump 364 and surface 363 are oriented toward an inner surface 370 of outer cabinet 16 of master monitor 12. Bump 364 is oriented away from securing assembly 40 of master monitor 12. A concave indent or receptacle 368 is formed in surface 366 of outer cabinet 18. Receptacle 368 is configured to receive bump 362 on securing assembly 40. A concave indent or receptacle 372 is formed in surface 370 of outer cabinet 16. Receptacle 372 is configured to receive bump 364 of securing assembly 40. Bump 362 is configured to fit within or mate with receptacle 368. Bump 364 is configured to fit within or mate with receptacle 372. Alternatively, bump 362 is formed on surface 366 of outer cabinets 18 and receptacle 368 is formed in surface 361 of securing assembly 40, and/or bump 364 is formed on surface 370 of outer cabinet and receptacle 372 is formed in surface 363 of securing assembly 42.

As monitor 12 and 14 are pushed together, bump 362 contacts surface 366 of outer cabinet 18 and bump 364 contacts surface 370 of outer cabinet 16, as shown in FIG. 6c. Receptacle 368 and bump 362 are configured such that when bump 362 makes initial contact with surface 366, a center portion of bump 362, i.e., a tip or peak of bump 362, is disposed over receptacle 368. Receptacle 372 and bump 364 are configured such that when bump 364 makes initial contact with surface 370, a center portion of bump 364, i.e., the tip or peak of bump 364, is disposed over receptacle 372. Adapting bump 362 and receptacle 368 and bump 364 and receptacle 372 such that the tip of bump 362 does not contact surface 366 and the tip of bump 364 does not contract surface 370, preserves a height of bumps 362 and 364, i.e., prevents bumps 362 and 364 from being worn down. Preserving the height of bumps 362 and 364 prevents a weakening of the securing assembly. Accordingly, monitors 12 and 14 can be pushed together and pulled apart as often as necessary without affecting the integrity of the securing assembly or the strength of the force with which monitor 12 and monitor 14 are held together.

FIG. 6d shows monitors 12 and 14 in travel mode. Bump 362 is seated or disposed in receptacle 368 and bump 364 is seated or disposed in receptacle 372. Bumps 362 and 364 seated in receptacles 368 and 372, respectively, hold monitors 12 and 14 together to prevent monitors 12 and 14 from unintentionally separating. Bumps 362 and 364 remain in receptacles 368 and 372, and monitors 12 and 14 remain together, until a force great enough to disengage bump 362 from receptacle 368 and bump 364 from receptacle 372 is applied to monitor system 10, as shown in FIG. 1d. Bumps 362 and 364 disposed in receptacles 368 and 372, respectively, securely affix master monitor 12 to remote monitor 14. Bumps 362 and 364 and receptacles 368 and 372 form a bump/receptacle securing mechanism that prevents monitor 12 and 14 from unintentionally separating. Bump/receptacle represents one type of securing mechanism that can be employed by monitor system 10 to secure master monitor 12 to remote monitor 14. The securing mechanism can also include latches, clips, brackets, magnetic coupling, Velcro, or other suitable mechanism that will prevent monitors 12 and 14 from unintentionally separating. Alternatively, as shown in FIG. 6e, monitor system 10 is placed in travel mode by applying a force to master monitor 12 and remote monitor 14 in a direction of arrows 380. Applying force in the direction of arrows 380 brings the faces of monitors 12 and 14 together, and causes securing assembly 40 of master monitor 12 to be disposed within cavity 186 of remote monitor 14 and securing assembly 42 of remote monitor 14 to be disposed within cavity 76 of master monitor 12. Bump 362 rests in receptacle 368 and bump 364 rests in receptacle 372 to prevent the bottom portions of monitors 12 and 14 from separating. Handle 24 is placed in close proximity to handle 26 to allow handle grip 28 to be place over both handles 24 and 26 and secure the top portions of monitors 12 and 14.

In another embodiment, shown in FIG. 6f, remote monitor 14 includes a securing assembly or tongue 382. Tongue 382 is formed on or coupled to a bottom portion of outer cabinet 18. A securing assembly or slot 384 is provided on a bottom portion of outer cabinet 16 of master monitor 12. Alternatively, master monitor 12 includes the tongue and remote monitor 14 the slot. Tongue 382 is aligned with and mated to slot 384. Disposing tongue 382 into slot 384 secures the bottom portion of master monitor 12 to the bottom portion of remote monitor 14. Tongue 382 in slot 384 prevents the bottom portions of monitors 12 and 14 from unintentionally separating. Tongue 382 forms a first portion of a tongue/slot securing mechanism. Slot 384 forms a second portion of the tongue/slot securing mechanism. Tongue/slot represents one type of securing mechanism that can be employed by monitor system 10. The securing mechanism can also include latches, clips, brackets, magnetic coupling, Velcro, or other suitable mechanism that will prevent monitors 12 and 14 from separating, when monitor system 10 is in travel mode. After disposing tongue 382 in slot 384, handle 24 of monitor 12 and handle 26 of remote monitor 14 are brought together by applying a force in the direction of arrows 386.

In FIG. 6g, handle grip 28 is disposed around handles 24 and 26. Protrusion 140 on handle grip 28 is configured to rest within groove 138 of handle 24 and groove 176 of handle 26. Protrusion 140 disposed in grooves 138 and 176 prevents handles 24 and 26 and monitors 12 and 14 from shifting or sliding horizontally. Protrusion 140 and grooves 138 and 176 keep the top portions of monitors 12 and 14 aligned and securely in place. Protrusion 140 disposed in grooves 138 and 176 also prevents grip 28 from slipping or sliding. Handles 24 and 26 increase the ease with which monitor system 10 can be carried and transported. Handle grip 28 provides a padding between the hand of a person carrying monitor system 10 and handles 24 and 26. Handle grip 28 makes monitor system 10 more comfortable to carry.

FIG. 6h shows monitor system 10 in travel mode. Monitor 12 is secured to monitor 14 so that monitor system 10 can be securely and easily carried as a single unit. Handle grip 28 is around handles 24 and 26 to prevent the top portions of monitors 12 and 14 from shifting and/or coming apart while monitor system 10 is being transported. Monitors 12 and 14 include a securing mechanism, e.g., bumps 362/364 and receptacles 368/372 or tongue 382 and slot 384, that prevents the bottom portions of monitors 12 and 14 from unintentionally separating. The face of master monitor 12 is oriented toward and is adjacent to the face of remote monitor 14. The edge of outer cabinet 16 contacts the edge of outer cabinet 18 to seal off the faces of monitors 12 and 14. The woofers, tweeters, baffles, and control panel located on the faces of monitors 12 and 14 are disposed inwardly and are protected from being dented or damaged while in transport. Monitor system 10 can be carried through rain, snow, wind, etc., because the outer cabinets of monitor 12 and 14 stay together and prevent external elements from coming into contact with the drivers and/or circuitry within monitor system 10.

The hard outer shell of monitor system 10, i.e., outer cabinets 16 and 18, protects the internal components of monitors 12 and 14 from being damaged if monitor system 10 is dropped or banged into during transport. Ribbing is formed along the wall of the outer cabinets to increase the bending stiffness and durability of monitor system 10 without adding excessive weight. The hollow structure and ribbing of the outer cabinets allows monitor system 10 to be both sturdy and lightweight. Remote monitor 14 of monitor system 10 includes a storage space, i.e., cavity 190. The storage space within remote monitor 14 allows accessories, e.g., audio cables, power chords, etc., to be conveniently stored and transported with monitor system 10. Storing and transporting accessories within remote monitor 14 keeps the accessories and monitors together, which prevents an accessory from being lost during transport. The storage space within remote monitor 14 also provides a place to store handle grip 28 when monitor system 10 is open, i.e., not in travel mode. Storing handle grip 28 within remote monitor 14 keeps handle grip 28 with monitor 14 to prevent handle grip 28 from being lost or misplaced. Handles 24 and 26 allow monitors 12 and 14 to be easily moved or transported. The portability and convenience of monitor system 10 allows an artist to bring a set of high quality studio monitors, with which the artist is familiar, to any location.

While one or more embodiments of the present invention have been illustrated in detail, the skilled artisan will appreciate that modifications and adaptations to those embodiments may be made without departing from the scope of the present invention as set forth in the following claims.

What is claimed is:

1. A portable speaker system, comprising:
a first monitor including a first securing assembly; and
a second monitor disposed adjacent to the first monitor and including a second securing assembly, wherein the first securing assembly and second securing assembly are configured to secure the first monitor to the second monitor.

2. The portable speaker system of claim 1, further including a first handle disposed over the first monitor and a second handle disposed over the second monitor.

3. The portable speaker system of claim 2, further including a handle grip disposed over the first handle and the second handle.

4. The portable speaker system of claim 1, wherein:
the first securing assembly includes a first portion of a first bump/receptacle mechanism;
the second monitor includes a second portion of the first bump/receptacle mechanism;
the second securing assembly includes a first portion of a second bump/receptacle mechanism; and
the first monitor includes a second portion the second bump/receptacle mechanism.

5. The portable speaker system of claim 1, further including a removable door disposed over a cavity formed in the second monitor.

6. The portable speaker system of claim 1, wherein a first outer cabinet of the first monitor and a second outer cabinet of the second monitor include a plurality of ribs.

7. A portable speaker system, comprising:
a first speaker including a first securing assembly; and
a second speaker including a second securing assembly, wherein the first securing assembly and second securing assembly are configured to secure the first speaker to the second speaker.

8. The portable speaker system of claim 7, further including a handle disposed over the first speaker.

9. The portable speaker system of claim 7, further including:
a first handle including a first groove disposed over the first speaker;
a second handle including a second groove disposed over the second speaker; and
a handle grip disposed over the first handle and second handle, wherein a protrusion of the handle grip is configured to rest in the first groove and second groove.

10. The portable speaker system of claim 7, wherein the first securing assembly includes a first portion of a bump/receptacle mechanism and the second securing assembly includes a second portion of the bump/receptacle mechanism.

11. The portable speaker system of claim 7, wherein the first speaker includes a high frequency diver, a midrange frequency driver, and a low frequency driver.

12. The portable speaker system of claim 7, wherein the first speaker includes a baffle disposed over an outer cabinet.

13. The portable speaker system of claim 12, wherein the baffle includes a lip recessed from a first surface of the baffle and formed around an opening in the baffle.

14. A portable speaker system, comprising:
a first speaker;
a second speaker; and
a securing assembly coupled to the first speaker and configured to secure the first speaker to the second speaker.

15. The portable speaker system of claim 14, wherein the first speaker includes a first high frequency driver and a first low frequency driver and the second speaker includes a second high frequency driver and a second low frequency driver.

16. The portable speaker system of claim 15, wherein the first speaker further includes a subwoofer with a frequency range of approximately 20 hertz to 200 hertz.

17. The portable speaker system of claim 15, wherein the first speaker further includes a first midrange frequency driver and the second speaker further includes a second midrange frequency driver.

18. The portable speaker system of claim 14, further including a handle disposed over the first speaker.

19. The portable speaker system of claim 14, wherein an outer cabinet of the first speaker includes a plurality of ribs.

20. A method of forming a portable speaker system, comprising:
providing a first speaker;
providing a second speaker; and
securing the first speaker to the second speaker.

21. The method of claim 20, further including:
providing a first portion of a bump/receptacle mechanism on the first speaker; and
providing a second portion of the bump/receptacle mechanism on the second speaker.

22. The method of claim 21, wherein securing the first speaker to the second speaker includes inserting the first portion of the bump/receptacle mechanism into the second portion of the bump/receptacle mechanism.

23. The method of claim 20, further including:
orienting a surface of the first speaker toward a surface of the second speaker; and
applying a first force to the first speaker and a second force to the second speaker to bring the surface of the first speaker and the surface of the second speaker together.

24. The method of claim 20, further including forming ribbing over a sidewall of the first speaker.

25. The method of claim 20, further including disposing a subwoofer with a frequency range of approximately 20 hertz to 200 hertz within the first speaker.
